(19) United States
(12) Patent Application Publication
(10) Pub. No.: US 2019/0196945 A1
(43) Pub. Date: Jun. 27, 2019

(54) ENTITY PERFORMANCE AND USABILITY ANALYSIS FRAMEWORK

(71) Applicant: SAP SE, Walldorf (DE)

(72) Inventor: Horst Schaude, Kraichtal (DE)

(21) Appl. No.: 15/850,377

(22) Filed: Dec. 21, 2017

(51) Int. Cl. G06F 11/36

(52) U.S. Cl. CPC G06F 11/3688; G06F 11/3692; G06F 11/3664

(57) ABSTRACT

Techniques are described for providing a framework for generically evaluating the performance and usability of custom entities in a development infrastructure. In an example method, a request to execute a performance and usability analysis on a particular entity within a cloud development system is received. An entity type associated with the particular entity is identified. Based on the identified entity type and from a repository of automated testing procedures, a first set of automated testing procedures corresponding to the particular entity is determined. The first set of automated testing procedures are executed on the particular entity, and a set of results associated with the execution of the first set of automated testing procedures is provided for presentation to a user interface.

### BACKGROUND

The present disclosure relates to a system and computerized method for providing a framework for generically evaluating the performance and usability of custom entities in a development infrastructure.

In some cloud-based systems, internal and external developers may be provided an opportunity to enhance, extend, or otherwise customize existing cloud applications and entities. Current systems are able to evaluate the new and modified entities to ensure those entities can be executed within the system based on existing syntax and grammar requirements. The new or modified entities can include, but are not limited to, coding snippets, mass data run objects (MDROs), user interfaces (UIs), or other suitable components.

### SUMMARY

Implementations of the present disclosure are generally directed to providing a framework for generically evaluating the performance and usability of custom entities in a development infrastructure. In one example implementation, a computerized method executed by hardware processors can be performed. The example method can comprise receiving a request to execute a performance and usability analysis on a particular entity within a cloud development system. An entity type associated with the particular entity is identified. Based on the identified entity type and from a repository of automated testing procedures, a first set of automated testing procedures corresponding to the particular entity is determined. The first set of automated testing procedures are executed on the particular entity, and a set of results associated with the execution of the first set of automated testing procedures is provided for presentation to a user interface.

Implementations can optionally include one or more of the following features. In some instances, the example method can further include accessing an entity definition associated with the particular entity, where the entity definition contains at least one operation performed by the particular entity. Based on the entity definition, a second set of automated testing procedures corresponding to at least one of the at least one operations performed by the particular entity can be determine. Further, executing the first set of automated testing procedures on the particular entity can include executing the first and second set of automated testing procedures on the particular entity. Further, providing the set of results can include providing the set of results associated with the execution of the first set of automated testing procedures and a set of results associated with the execution of the second set of automated testing procedures.

In some of those instances, the entity definition includes at least one of an identification of a particular function performed by the particular entity, a particular format of the particular entity, and one or more programming languages associated with the particular entity.

In some of those instances, determining the second set of automated testing procedures corresponding to the at least one of the at least one operations performed by the particular entity can include determining the second set of automated testing procedures based on the identified entity type and the entity definition of the particular entity.

In some instances, identifying an entity type associated with the particular entity is based on at least one of a file name extension of the particular entity, metadata associated with the particular entity, one or more attributes or parameters associated with or related to the particular entity, and an entry associated with the particular entity included in a lookup table or index storing information related to a plurality of entities.

In some instances, providing the set of results associated with the execution of the first set of automated testing procedures can include identifying at least one issue corresponding to the set of results of the execution. In some of those instances, identifying the at least one issue includes identifying a location within the particular entity associated with at least one of the at least one identified issues.

In some instances, the request to execute the performance and usability analysis on the particular entity can be an automatically triggered request in response to a developer action associated with development of the particular entity.

Similar operations and processes may be performed in a system comprising at least one processor and a memory communicatively coupled to the at least one processor where the memory stores instructions that when executed cause the at least one processor to perform the operations. Further, a non-transitory computer-readable medium storing instructions which, when executed by at least one processor, cause the at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for implementing a framework for evaluating the performance and usability of custom entities created in a cloud-based development infrastructure.

FIG. 2 represents an example flow for evaluating custom entities in a cloud-based development infrastructure in one implementation of the present disclosure.

FIG. 3 is an example illustration of an example class hierarchy tree identifying a set of analyses and testing to be performed on particular entities in one implementation of the present disclosure.

### DETAILED DESCRIPTION

The present disclosure describes systems and methods for providing a framework for generically evaluating the performance and usability of custom entities in a development infrastructure. In some instances, a software provider or ecosystem developer may provide an infrastructure to allow customers to enhance solutions through a partner development system, such as SAP's Partner Development Infrastructure (PDI). In doing so, services and functionality can be defined by third parties to incorporate or build upon the original applications and functionality provided by the developer and development team. Entities that can be enhanced or created can include, among others, coding snippets, mass data run objects (MDROs), user interfaces (UIs), development objects (DOs) (including business objects (BOs)), and BO modeling information.

In standard development infrastructures, various checks associated with developed entities can be executed to ensure that runtime artifacts can be produced from the developed entities in a manner suitable for the infrastructure, such as by confirming that any syntax or grammar rules are met by the entity. For example, a code snippet in a particular programming language can be checked to ensure that the syntax of the code satisfies any underlying syntax or grammar rules by a parser and/or lexer. The check can confirm whether the code snippet is syntactically correct and whether it can be used within the associated system. However, such checks do not ensure that the underlying code makes sense, solves the issue it is being created for, nor whether actually executing the coding snippet will create issues or inefficiencies in operation. In other words, a framework including and for executing a set of checks related to the performance and usability of the newly defined entities is not provided in current systems, requiring developers to manually analyze their code or perform significant debugging and code analysis to improve their entities. In current systems, developers may be able to generate entities that perform the function intended, but which do so poorly, such as through repetitive calls to a same set of remotely stored data requiring significant network or processing resources. In such an instance, for example, a single call to the remotely stored data can be used and a local variable storing that data instantiated. Future accesses of the remote data can be amended or modified to call the local variable, providing faster access to the information while saving significant resources. Other repetitive actions that perform their intended functionality may do so with a measurable or identifiable inefficiency, such as with coding or actions that may cause potential issues, slowness, or a waste of resources. For example, mass data run objects are designed to select the data to be associated with an execution in predefined queries and then to execute some corresponding code upon the retrieved data. If queries occur within the code, a longer runtime will be experienced. For UIs, communication with a backend system or component is the normal bottleneck for UI interactions. Calls to the backend should thus be bundled or sent at a single time to avoid additional or multiple bottlenecks.

The framework described herein allows users, developers, and administrators to test custom entities for performance and usability issues in the development infrastructure in an automatic and generic manner. In some instances, a class hierarchy tree can be defined to include particular testing processes and operations associated with such checks on multiple hierarchical levels. The class hierarchy tree can organize a set of performance and usability checks at various levels and for different data types to ensure that, in response to a triggered initiation of the performance and usability checks, an automated process is used to identify the particular checks to be performed on the particular entity based on the entity's type and based on any other information specific to the entity, such as the operations, data requests, interactions, and other functionality defined by or included in such entities.

In some instances, the class hierarchy tree can be used by the framework to identify a particular set of operations to be performed. First, the framework determines the entity type of the particular entity to be checked. In some instances, a first set of operations may be associated with all entities such that those operations are performed in each instance. Within the entity analyzer, a set of subclasses may be included which identify different general types of entities, such as a UI, code snippets, an MDRO, etc. Each of those subclasses may be associated with a set of analysis methods and operations to be used in the check. Still further, different subclasses of the particular entity type may be identified, such that entities of those different subclasses may be associated with different types of additional checks. In still other instances, the substance of a particular entity, or metadata associated therewith, may determine additional checks and operations to be performed on those entities in addition to those based on a particular entity type or subtype.

In response to executing the set of performance and usability checks associated with the particular entity, one or more issues may be identified by the framework and its components. In some instances, information associated with the one more identified issues can be provided to a person, team, or development entity associated with the particular entity being analyzed. Those issues may be associated with one or more proposed solutions or suggestions on how to correct the issues. Additionally, the location of the issue within the particular entity can be identified in the feedback provided. An analysis UI may be provided to present information on the issues identified, the location of the issues within the particular entity, and any solutions or suggestions proposed or identified by the framework. In some instances, links to the programming or content defined by the particular entity may be provided such that an associated developer or user may be able to quickly access the particular entity to view and correct the issue without additional work.

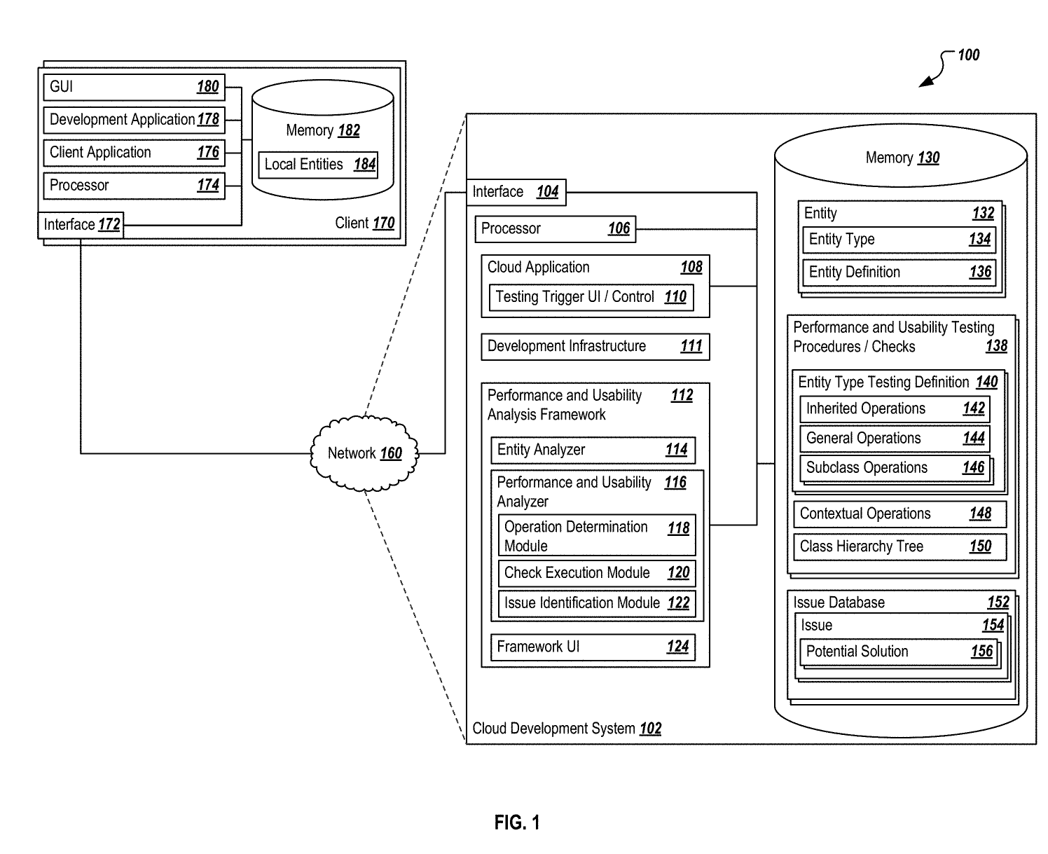

Turning to the illustrated implementation, FIG. 1 is a block diagram illustrating an example system 100 for implementing a framework for evaluating the performance and usability of custom entities created in a cloud-based development infrastructure. As illustrated in FIG. 1, system 100 is associated with a cloud-based system for allowing extensibility and partner development as it relates to an underlying application (e.g., the cloud application 108), and can allow users and developers to initiate performance and usability analyses upon particular entities created or modified within the system 100. The system 100 allows the illustrated components to share and communicate information across devices and systems (e.g., cloud development system 102, and client 170, among others, via network 160). As described herein, the cloud development system 102 may be cloud-based component or system, while in other instances, non-cloud systems may be used. In some instances, non-cloud-based systems, such as on-premise systems, may use or adapt the processes described herein. Although components are shown individually, in some implementations, functionality of two or more components, systems, or servers may be provided by a single component, system, or server.

As used in the present disclosure, the term “computer” is intended to encompass any suitable processing device. For example, cloud development system 102 and client 170 may be any computer or processing device such as, for example, a blade server, general-purpose personal computer (PC), Mac®, workstation, UNIX-based workstation, or any other suitable device. Moreover, although FIG. 1 illustrates a single cloud development system 102, the system 102 can be implemented using a single system or more than those illustrated, as well as computers other than servers, including a server pool. In other words, the present disclosure contemplates computers other than general purpose computers, as well as computers without conventional operating systems. Similarly, the client 170 may be any system which can request data and/or interact with the cloud development system 102. The client device 170, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The client 170 may include one or more specific applications executing on the client 170, or the client 170 may include one or more Web browsers or web applications that can interact with particular applications executing remotely from the client 170.

The cloud development system 102 may be associated with the one or more cloud-based applications (e.g., cloud application 108), and may be associated with or a part of a cloud platform such as SAP's Cloud Platform or Cloud Application Studio. In some instances, the cloud development system 102 may be associated with a software development kit (SDK) and a development infrastructure (DI). In some instances, the cloud development system 102 may provide an environment where developers, partners, and other users can interact with, expand, and modify the operations of an existing platform through the creation, design, and modification of one or more platform-related entities. The cloud development system 102 may be a part or portion of a larger cloud platform (not shown) where new or extended entities (as compared to those provided by the cloud software developer) are created, developed, and/or tested.

As illustrated, the cloud development system 102 includes or is associated with interface 104, processor 106, cloud application 108, a performance and usability analysis framework 112, and memory 130. The interface 104 is used by the cloud development system 102 for communicating with other systems in a distributed environment—including within the environment 100—connected to the network 160, e.g., client 170, other cloud systems, on-premise systems, data sources, and others as well as other systems communicably coupled to the illustrated cloud development system 102 and/or network 160. Generally, the interface 104 comprises logic encoded in software and/or hardware in a suitable combination and operable to communicate with the network 160 and other components. More specifically, the interface 104 may comprise software supporting one or more communication protocols associated with communications such that the network 160 and/or interface's hardware is operable to communicate physical signals within and outside of the illustrated environment 100. Still further, the interface 104 may allow the cloud development system 102 to communicate with the client 170 in response to specific requests related to the cloud application 108, the framework 112, and/or particular entities 132, as described in the present disclosure.

Network 160 facilitates wireless or wireline communications between the components of the environment 100 (e.g., between the cloud development system 102 and the clients 170), as well as with any other local or remote computer, such as additional mobile devices, clients (e.g., client 170), servers, or other devices communicably coupled to network 160, including those not illustrated in FIG. 1. In the illustrated environment, the network 160 is depicted as a single network, but may be comprised of more than one network without departing from the scope of this disclosure, so long as at least a portion of the network 160 may facilitate communications between senders and recipients. In some instances, one or more of the illustrated components (e.g., the cloud development system 102) may be included within network 160 or a portion thereof as one or more cloud-based services or operations, including those associated with a cloud platform. The network 160 may be all or a portion of an enterprise or secured network, while in another instance, at least a portion of the network 160 may represent a connection to the Internet. In some instances, a portion of the network 160 may be a virtual private network (VPN). Further, all or a portion of the network 160 can comprise either a wireline or wireless link. Example wireless links may include 802.11a/b/g/n/ac, 802.20, WiMax, LTE, and/or any other appropriate wireless link. In other words, the network 160 encompasses any internal or external network, networks, sub-network, or combination thereof operable to facilitate communications between various computing components inside and outside the illustrated environment 100. The network 160 may communicate, for example, Internet Protocol (IP) packets, Frame Relay frames, Asynchronous Transfer Mode (ATM) cells, voice, video, data, and other suitable information between network addresses. The network 160 may also include one or more local area networks (LANs), radio access networks (RANs), metropolitan area networks (MANs), wide area networks (WANs), all or a portion of the Internet, and/or any other communication system or systems at one or more locations.

The cloud development system 102 also includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the cloud development system 102, in particular those related to the cloud application 108 and the framework 112. Specifically, the processor 106 executes the algorithms and operations described in the illustrated figures, as well as the various software modules and functionality, including the functionality for sending communications to and receiving transmissions from clients 170, as well as to other devices and systems. Each processor 106 may have a single or multiple core, with each core available to host and execute an individual processing thread. Further, the number of, types of, and particular processors 106 used to execute the operations described herein may be dynamically determined based on a number of requests, interactions, and operations associated with the cloud development system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The cloud application 108 may be any application, program, agent, or other software capable of executing in a cloud-based system. In some instances, the illustrated version of the cloud application 108 may be associated with a development or testing environment associated with the cloud development system 102, as well as a productive system associated with the cloud platform associated with the cloud development system 102. In some instances, the cloud application 108 can be used to develop new or modified entities 132, while in other instances the cloud application 108 executes or interacts with those entities, where an external application or environment provides the entities 132, such as development application 178 of client 170 or development infrastructure 111 or another environment within the cloud development system 102. In some instances, the cloud application 108 may be initially associated with a default set of entities 132 provided by the software developer or provider of the cloud platform, with additional custom or newly created entities 132 added by one or more contributors, including partners, customers, and other persons or organizations.

In some instances, the cloud application 108 may be associated with business software and/or an end-to-end business solution system, such as an enterprise resource planning (ERP) system, a customer resource management (CRM) system, business intelligence systems, cloud platform systems, supplier management (SM) system, or any other suitable business or non-business system.

The cloud application 108 may be associated with or can include one or more testing trigger user interfaces (UIs) or controls 110 that users can activate or interact with to initiate or cause a performance and usability analysis to be triggered. In some instances, the development environment may include one or more commands, buttons, or other controls that allow the analysis to be initiated by the developer of a particular entity 132 or by another user interacting with said entity 132. In some instances, the control 110 may be triggered in response to a completion, finalization, or saving of a particular entity 132 being developed. In still other instances, controls 110 may be included or available within a UI associated with the cloud application 108, such as when a particular entity 132 is being executed, acted upon, or otherwise interacted with. The control 110 can then be activated to initiate the analysis and cause the entity 132 to be evaluated using the framework 112.

As mentioned above, in some instances, entities 132 may be developed, created, and modified in a development infrastructure 111 available within the cloud development system 102. The development infrastructure 111 may provide a dedicated location, subsystem, component, application, or other development or coding environment where developers can create and modify new and existing entities 132. Entities 132 created in the development infrastructure 111 (or in other suitable locations) can be stored in memory 130 described below. The custom entities 132 can be stored with existing or default entities, or they can be stored and maintained separately. The entities 132 can include, but are not limited to, coding snippets or other runtime code, UIs or UI elements, mass data run objects (MDROs), business objects (BOs), BO modeling information, and others. The entity type 134 of the particular entity 132 can be defined within or associated with the entity 132. In some instances, the entity type 134 can be defined or made available based on a file name extension of the entity 132, based on metadata associated with the stored entity 132, based on attributes or parameters associated with or related to the entity 132, based on a lookup table or index storing information about the entity 132, or in any other suitable manner. In some instances, the entity type 134 may be defined on a first hierarchical level (e.g., code, UI, etc.). Additional information about the entity type 134 may be available to determine one or more subclasses with which the entity 132 is to be classified. For example, an entity type 134 of a code snippet may be that the entity is code. The subclass of the code may be associated with the particular programming language in which the code is written. Subclasses can inherit a particular set of analysis operations from the parent class, and can also have one or more additional operations associated only with the subclass.

Additionally, each entity 132 may be associated with an entity definition 136, where the entity definition 136 can identify entity-specific coding, information, function calls, operations, and other details related to the particular entity 132. The entity definition 136 can be analyzed by the framework 112 (and its components) to identify particular contextual operations 148 to be performed during the analysis operations. Additionally, the entity definition 136 may be the subject of the testing checks described herein, including the particular calls, operations, and actions associated with the entity 132. In some instances, the entity definition 136 may provide or include additional information that can be used to identify a subclass of a particular entity type 134 to which the entity 132 belongs or should be classified within.

The framework 112 of the cloud development system 102 provides the operations and support for performing the particular operations associated with the analysis of particular entities 132 for performance and usability, and providing those results and suggested solutions to any identified issues to users or developers. The framework 112 as illustrated includes several sub-components and modules, but the framework 112 may be implemented as a single component, multiple related components, two or more separate components, or in any combination or permutation such that at least a portion of the functionality described herein can be performed sufficiently. In the current illustration, the framework 112 includes an entity analyzer 114, a performance and usability analyzer 116, and a framework UI 124.

The entity analyzer 114 can perform operations to identify an entity type of the particular entity 132 being analyzed. Initially, the entity analyzer 114 may be capable of identifying within memory 130 where information related to a particular entity 132 is stored. The information may include a dedicated file associated with the entity 132, as well as distributed information in one or more tables or other artifacts defining or associated with the particular entity 132. The entity analyzer 114 may then, in some instances, perform the entity type analysis based on predefined information explicitly associated with the entity 132 (e.g., the entity type 134 information), while in other instances the entity analyzer 114 may perform one or more determinations of the entity definition 136 or other related data, metadata, or other information defining the entity to determine the particular entity type of the entity 132. In some instances, a general entity type may be identified from the entity type 134 information, while one or more subclasses or additional classification information can be identified from the entity definition 136. In some instances, additional context may be analyzed within the entity definition 136 to determine non-type related contextual operations 148 to be included in the analysis.

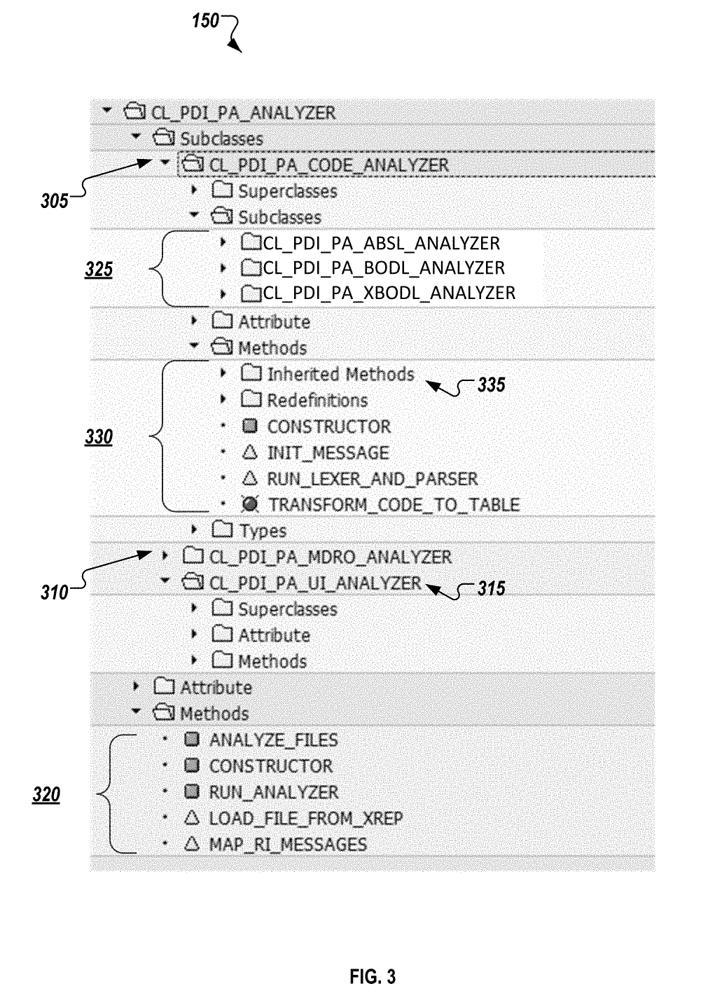

The performance and usability analyzer 116 can use the information identified by the entity analyzer 114 to determine the particular operations to be executed in the analysis using the operation determination module 118. The operation determination module 118 can perform several actions to determine the analysis operations to be performed. In one implementation, one or more entity-type based operations can be identified and included in the analysis from the set of performance and usability testing procedures 138 (illustrated as stored in memory 130). The set of performance and usability testing procedures 138 can include multiple entity type testing definitions 140, where different entity types are associated with one or more analysis operations to be performed during the framework's analysis execution. Each entity type may be associated with a particular set of operations to be performed when a particular entity 132 of that type is analyzed. As illustrated in the entity type testing definition 140, each entity 132 can be associated with a set of inherited operations 142 inherited from a relatively higher level of a class hierarchy, general operations 144 associated with the particular entity type 134, and one or more sets of subclass operations 146 associated with different subclasses of the associated entity type 134. The particular subclass to which an entity 132 is classified may be determined based on an analysis of the entity type 134 information or the entity definition 136. The subclasses operations 146 can then be applied where the entity 132 is determined to belong to or be associated with the particular corresponding subclass. In some instances, a class hierarchy tree 150 may be provided, defined, generated, or otherwise available to describe the particular set of operations and actions available for a particular entity type. An example class hierarchy tree 150 is illustrated in FIG. 3 and is described herein.

The example class hierarchy tree 150 of FIG. 3 includes a set of subclasses to be used for different types of entity types. In particular, the set of subclasses includes a code snippet subclass 305, an MRDO subclass 310, and a UI subclass 315. Additional and/or alternative subclasses can be added in alternative implementations. Within the class hierarchy tree 150, a set of high-level methods 320 are inherited by each of the subclasses 305, 310, and 315. Additionally, each subclass 305, 310, and 315 can be associated, in some instances, with one or more of its own subclasses (e.g., where the code subclass 305 includes three different subclasses 325 for different types of code). Additionally, each of the subclasses 305, 310, 315 can be associated with one or more methods and/or operations to be performed for the specific subclass. As illustrated in methods 330 for the code subclass 305, the methods 330 include inherited methods 335 from the higher level classes, as well as additional methods specific to the particular subclass 305. For the three different subclasses 325 of the code class 305, additional methods specific to the particular subclass 325 can be further applied if the particular entity is associated with that subclass. Additional hierarchical layers of subclasses can be provided in other implementations.

The class tree hierarchy 150 may be a representation of the various rules and operations associated with a plurality of entity types. However, each entity type may be individually associated with a complete set of operations to be performed in the performance and usability analysis without the class tree hierarchy 150 being used, or in addition to the class tree hierarchy 150. The class tree hierarchy 150 can be used, however, to simplify the illustration of the particular operations to be applied to a particular entity 132 based on its entity type 134.

FIG. 3 is meant to provide an example class hierarchy 150, and is not meant to be restrictive on further implementations. Additional, fewer, and alternative subclasses may be provided in alternative implementations at different levels in the hierarchy. Further, customers, administrators, and others may expand or enhance the class hierarchy 150 in extended solutions, such as by defining particular subclasses and operations/checks to be performed on particular subclasses, including subclasses within one or more of the high level subclasses 305, 310, 315.

Returning to FIG. 1, one or more context-based or contextual operations 148 can be determined based on the content of the particular entity 132, or based on the entity's entity definition 136 and the actual coding or logic included within the entity 132. The contextual operations 148 may be specific to particular actions performed by an entity 132 (e.g., a remote data call or request), particular functions to be performed (e.g., data verification), or based on any parameters or contextual information associated with the particular entity 132. Those contextual operations 148 can be defined within the performance and usability testing procedures 138, and applied, where appropriate, by the operation determination module 118. In some instances, these contextual operations 148 may be specifically associated with particular subclass types, such that certain contextual operations 148 are only used for particular entity types when the particular entity is of that particular entity type and, further, where the particular entity's entity definition 136 (or other attributes or metadata) match or satisfy the requirements for using the particular contextual operation 148. In other instances, the contextual operations 148 may be triggered for any and all entity types where the particular entity matches or satisfied the corresponding contextual operation 148 requirements.

Once the particular operations to be executed are determined, the check execution module 120 can perform the determined analysis operations on or in reference to the particular entity 132. The check execution module 120 can obtain a list of the particular determined operations from the testing procedures 138 to be applied, and can then execute those operations sequentially, concurrently, or a combination thereof. In some instances, one or more of the operations may require the output of a related analysis. In those instances, the check execution module 120 can perform those analysis operations in a suitable order.

The output of a particular execution of the determined operations is one or more sets of output used to identify, where appropriate, one or more issues in the analyzed entity 132. Each operation executed may be associated with a plurality of potential outcomes, from determining that the particular operation detects no errors or issues to the identification of a particular, measured issue after the execution of the operation. In some instances, particular operations may be capable of returning multiple different issues. The issue identification module 122 can receive output of the execution of the various checks and testing procedures and identify the corresponding issues based on the output. In some instances, the issue identification module 122 can consult or access an issue database 152 storing a plurality of potential issues 154 capable of being raised by one or more of the procedures 138. The potential issues 154 may be known or defined prior to execution of the various procedures 138 as possibly related to the outcome of one or more of the procedures 138. In response to an error or output of a particular procedure's execution, a corresponding issue 154 can be identified, such as by matching error codes generated by the procedure to the one or more issues 154, correlating execution results of the testing to one or more of the issues 154, or based on any other feedback or output generated by the procedures' execution and its relation to one or more of the issues 154. The issue identification module 122 can, in some instances, identify particular portions, lines, functions, operations, or other parts of the entity 132 at which the issues occur based on the outcome of the execution. Additionally, at least some of the issues 154 may be associated with one or more potential solutions 156. The potential solutions 156 may be static help information or they may be adaptable to incorporate real-time information associated with the outcome of a particular analysis procedure 138 within the potential solution 156. The solutions 156 may include an example of one or more changes that may correct or fix the identified issue 154, or may identify specific error locations that are throwing the error or causing the detected problem or inefficiency. The issue identification module 122 can take this information, including the identification of the issue 154 and, optionally, either or both of one or more potential solutions 156 associated with the identified issue 154 and locations within or portions of the particular entity 132 where the issue is detected or identified, and provide that information to a framework UI 124 for presentation to a user or developer associated with the triggered analysis and/or the underlying entity 132. For users or developers associated with the triggered analysis, the framework UI 124 can be presented as a pop-up window, a portion of an existing window in which the user or developer is operating, or can be associated with electronic message such as an email. The framework UI 124 may be a dedicated UI used to present the analysis results, or the framework UI 124 may instead be used to format the results and send a message to one or more applications or other interfaces for presentation.

The issue identification module 122 may perform or manage the generation and/or completion of result messages to be provided back to developers or users associated with the particular entity 132 being analyzed. In some instances, a template format can be provided for various issues, with the issue identification module 122 placing or inserting the relevant information about the current analysis into the template. The result set can be provided or mapped into a format that the developer and/or associated user can understand, and that provides details needed to address the issue in an efficient manner. In some instances, navigational links to the particular entity 132 and/or its entity description 136 may be included with the result message or presentation. In some instances, those links can be used to access the entity 132 at the proper location, such that solving the identified issue can be performed immediately. The links may include a hyperlink to or another suitable locator or identifier of or to the entity 132 (e.g., a uniform resource locator (URL) or a uniform resource identifier (URI)), an attachment including the entity 132 or the portion of the entity 132 associated with the issue, or any other suitable indication.

Memory 130 may represent a single memory or multiple memories. The memory 130 may include any memory or database module and may take the form of volatile or non-volatile memory including, without limitation, magnetic media, optical media, random access memory (RAM), read-only memory (ROM), removable media, or any other suitable local or remote memory component. The memory 130 may store various objects or data (e.g., the described entities 132, testing procedures 138, and issue database 152, as well as others, etc.), including financial data, user information, administrative settings, password information, caches, applications, backup data, repositories storing business and/or dynamic information, and any other appropriate information associated with the cloud development system 102, including any parameters, variables, algorithms, instructions, rules, constraints, or references thereto. Additionally, the memory 130 may store any other appropriate data, such as VPN applications, firmware logs and policies, firewall policies, a security or access log, print or other reporting files, as well as others. While illustrated within the cloud development system 102, memory 130 may be located remote from the cloud development system 102 in some instances, including as a cloud application or repository, or as a separate cloud application or repository when the cloud development system 102 itself is a cloud-based system.

As illustrated, one or more clients 170 may be present in the example system 100. Each client 170 may be associated with requests transmitted to the cloud development system 102 related to the analysis framework 112 and/or the cloud application 108. In some instances, one or more of the clients 170 may submit requests or actions that trigger the analysis of a particular entity 132 as described herein. In other instances, one or more clients 170 may be associated with the generation, customization, or modification to one or more of the entities 132. As illustrated, the client 170 may include an interface 172 for communication (similar to or different from interface 104), at least one processor 174 (similar to or different from processor 106), a client application 176, a development application 178, a graphical user interface (GUI) 180, and a memory 182 (similar to or different from memory 130).

The illustrated client 170 is intended to encompass any computing device such as a desktop computer, laptop/notebook computer, mobile device, smartphone, personal data assistant (PDA), tablet computing device, one or more processors within these devices, or any other suitable processing device. In general, the client 170 and its components may be adapted to execute any operating system, including Linux, UNIX, Windows, Mac OS®, Java™, Android™, or iOS. In some instances, the client 170 may comprise a computer that includes an input device, such as a keypad, touch screen, or other device(s) that can interact with the client application 176 and/or the development application 178 (where available), and an output device that conveys information associated with the operation of the applications and their application windows to the user of the client 170. Such information may include digital data, visual information, or a GUI 180, as shown with respect to the client 170. Specifically, the client 170 may be any computing device operable to communicate queries or communications to the cloud development system 102, other clients 170, and/or other components via network 160, as well as with the network 160 itself, using a wireline or wireless connection. In general, client 170 comprises an electronic computer device operable to receive, transmit, process, and store any appropriate data associated with the environment 100 of FIG. 1.

Client application 176 may be any suitable application, program, mobile app, or other component. As illustrated, the client application 176 interacts with the cloud development system 102 via network 160. In some instances, the client application 176 may be a browser, where the functionality of the client application 176 may be realized using a web application or website the user can interact with via the client application 176. In other instances, the client application 176 may be a remote agent, component, or client-side version of the cloud development system 102, the cloud application 108, or another component. In some instances, the client application 176 may interact directly with the cloud development system 102, the cloud application 108, and/or the development infrastructure 111. Similarly, the development application 178 may be a standalone application for entity development and modification executing at the client 170, or may be an agent or component associated with the development infrastructure 111.

GUI 180 of the client 170 interfaces with at least a portion of the environment 100 for any suitable purpose, including generating a visual representation of the client application 176, the development application 178, and/or the content associated with either the client application 176 or the development application 178. In particular, the GUI 180 may be used to present results of the performance and usability analysis from the framework 112, update or interact with one or more entities 132, or interact and present information associated with one or more applications. GUI 180 may also be used to view and interact with various Web pages, applications, and Web services located local or external to the client 170. Generally, the GUI 180 provides the user with an efficient and user-friendly presentation of data provided by or communicated within the system. The GUI 180 may comprise a plurality of customizable frames or views having interactive fields, pull-down lists, and buttons operated by the user. In general, the GUI 180 is often configurable, supports a combination of tables and graphs (bar, line, pie, status dials, etc.), and is able to build real-time portals, application windows, and presentations. Therefore, the GUI 180 contemplates any suitable graphical user interface, such as a combination of a generic web browser, a web-enable application, intelligent engine, and command line interface (CLI) that processes information in the platform and efficiently presents the results to the user visually.

Memory 182 of the client 170 may be similar to memory 130 as described above. As illustrated, memory 182 may include or be associated with one or more locally defined entities 184 created or interacted with using the development application 178. In response to finalizing a particular entity 184, a synchronization operation can be performed to migrate or store the particular local entity 184 with the set of entities 132 at the cloud development system 102. In some instances, the local version of the local entity 184 at the client 170 may be kept, while in others, the local version can be deleted or removed from the client 170. In some instances, the local entities 184 may include one or more entities obtained from the set of entities 132, where the local version of those entities 184 can be updated, modified, or otherwise interacted with at the client 170 (e.g., using the development application 178).

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

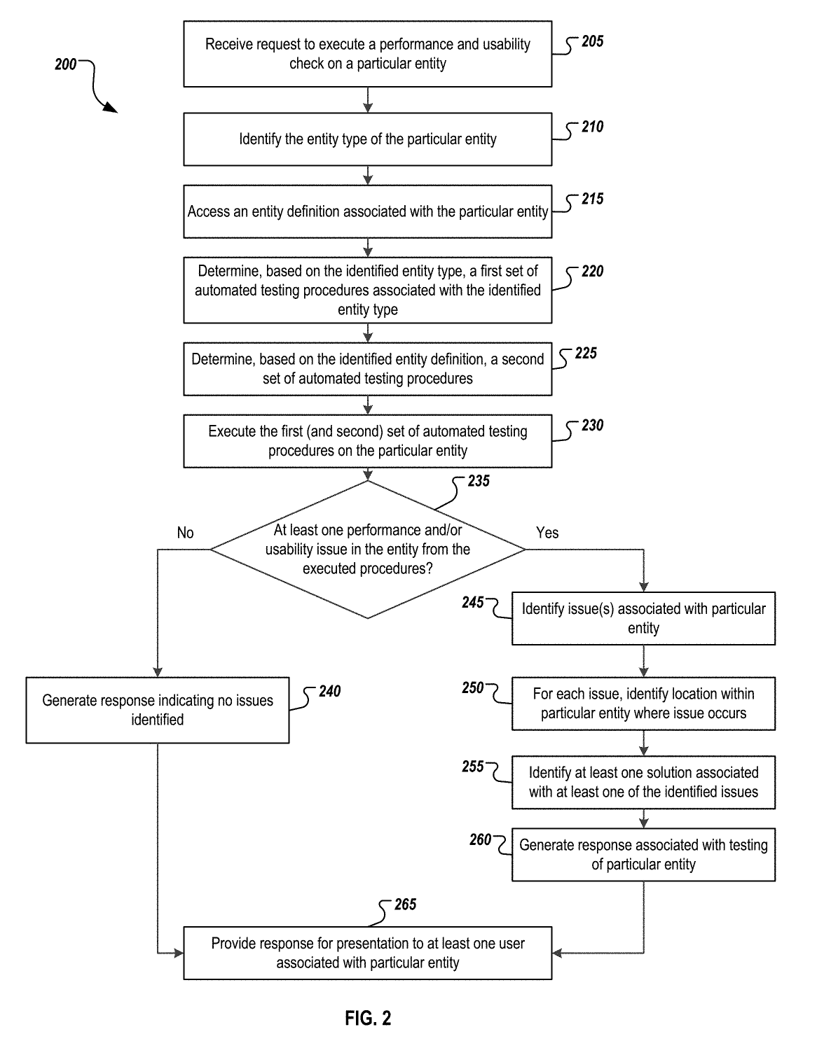

FIG. 2 represents an example flow for evaluating custom entities in a cloud-based development infrastructure in one implementation of the present disclosure. For clarity of presentation, the description that follows generally describes method 200 in the context of the system 100 illustrated in FIG. 1. However, it will be understood that method 200 may be performed, for example, by any other suitable system, environment, software, and hardware, or a combination of systems, environments, software, and hardware as appropriate. In some instances, method 200 can be performed by the cloud development system 102, or portions thereof, described in FIG. 1.

At 205, a request to execute a performance and usability check or analysis on a particular entity is received. The request may be a manual request from a particular user or developer associated with a particular entity or set of entities. In some instances, the manual request may be initiated by a person who is not a developer of the entity, but who is instead interacting with the entity in a testing or production environment. The manual request may be based on an identified issue (e.g., slowness, delays, etc.) experienced while interacting with the entity or with an application using or associated with the particular entity. The manual request may be triggered by a control or other UI-related input presented in a user interface. In other instances, the request may be based on an automatic trigger or event occurring within the system. For example, performance and usability analyses may be automatically triggered in response to the saving of a new entity within the system, in response to an internal system indication or setting indicating that development has been completed for a particular entity (e.g., as tagged or set by the developer), or in response to any other suitable event. In some instances, a request may identify or be associated with a plurality of entities, such as when a request for a performance and usability analysis is made while interacting with an application incorporating two or more custom entities, such as a custom UI and a portion of custom code. The framework may be able to determine the custom entities associated with a state or application in which the request for the analysis was received to determine the relevant entities to be checked. This may occur, for example, where performance issues are identified or noticed by a user while working with particular functionality or application, but where multiple entities are present. When the request is triggered, analyses of each of the associated entities can be performed (e.g., sequentially, concurrently, etc.).

In response to the received request, an entity type of the particular entity can be determined. The entity type may be defined in or associated with the particular entity. In some instances, the entity type can be derived from information associated with the entity, including in metadata or attributes associated with the entity. In some instances, the entity type can be determined based on information defining the entity, metadata associated with the entity, the location at which the entity is stored, a file extension of the entity, or based on an explicitly defined entity attribute included within the entity, among others. Information associated with the particular entity can be stored with the entity directly, or can be stored separate from the entity in a table, database, index, or other configuration or entity-related files, documents, or locations. In some instances, determining the entity type of the particular entity may require an analysis of the entity's definition, or the code or other components from which the entity is created or made. The entity type can be used to identify at least a portion of the relevant testing procedures that are to be performed for the performance and usability analysis. In some instances, the entity type of a particular entity may be determined at a first level, wherein additional analysis of the particular entity is required to identify the entity's association with one or more additional subclasses within the first entity type.

At 215, an entity definition associated with the particular entity can be accessed. The entity definition may be used to identify the entity type of the particular entity, in some instances. The entity definition may be stored within or associated with the entity, and may be at the same or different locations from where the information identifying the entity type can be found. In some instances, the entity definition may include specific coding, operations, and functionality performed by the particular entity. The entity definition may be the actual coding and operations associated with the particular entity, or the entity definition may include a reference to at least a subset of the operations and functionality performed by the particular entity. The entity definition can be used to identify additional or other appropriate testing procedures to be performed on the particular entity during testing.

At 220, based on the identified entity type, a first set of automated testing procedures can be determined that are to be performed on the particular entity, where those automated testing procedures are specifically associated with the entity type of the particular entity. For example, the entity type of the particular entity may be associated with one or more performance and usability testing procedures as described in FIG. 1. In some instances, the entity type determined at 210 may be an entity type at a first level within an entity type hierarchy. The first level within the entity type hierarchy may be associated with a first subset of procedures to be included within the first set of automated testing procedures, wherein the first subset of procedures includes one or more inherited testing procedures and/or other operations associated with a relatively higher hierarchical level of entity types, or which were inherited from the general testing procedures for all entities. Further, a second subset of procedures may be determined based on a subclass of the entity type with which the particular entity is classified. For example, a first hierarchical level may identify a set of procedures for code snippets or other code-related entities. The subclass, or relatively lower second hierarchical level may be specific to certain programming languages, and apply certain language-specific testing procedures based on the particular unique aspects of that language. The analysis at 220 can include, in some instances, a determination of at least one subclass within the entity type associated with the particular entity to which the particular entity is associated. One or more subclass-specific procedures associated with the at least one subclass in the set of testing procedures can be included in the determined first set of automated testing procedures at 220.

At 225, a second set of automated testing procedures can be determined based on the accessed entity definition of 215. As noted, the entity definition can identify or include particular operations or functionality (e.g., calls, call types, programming, data requests, database interactions, etc.) included within or associated with the particular entity. Different automated testing procedures can be associated with particular types of operations and functionality apart from a particular entity's type. In those instances, the framework described herein can identify, in addition to the entity type-specific testing procedures, one or more of a second set of automated testing procedures associated with the particular entity and its entity definition. The second set of testing procedures may be contextual, or based on factors other than the entity type of the particular entity. In some instances, the second set of automated testing procedures can be specific testing procedures associated with a particular entity type, but which are based on the accessed entity definition of 215. In other words, the entity type may be associated with one or more context- or content-specific automated testing procedures, such that those context-specific automated testing procedures are only triggered for use when the entity includes or is associated with a context (e.g., metadata, attributes, particular procedures or functions within the defined entity, particular coding or programming language, or other information, content, or context) that matches that as associated with the second set of testing procedures. The second set of automated testing procedures may not be identified for each entity, or may not be included in some implementations.

At 230, the first—and if applicable, second—set of automated testing procedures can be executed by the framework on or related to the particular entity. The output of the various procedures can be used to identify one or more issues associated with the particular entity as described in FIG. 1. Following the execution, a determination whether at least one performance and/or usability issue is identified in relation to the particular after execution of the testing procedures is made at 235. If no issues are identified, method 200 continues at 240. If, however, one or more issues are identified, method 200 continues at 245.

When no issues are identified after the testing procedures, at 240 the framework confirms that no issues are identified and can generate, where appropriate, a response indicating that no issues are identified. In some instances, when no issues are found, no response may be generated, or the response may be simple and indicate that no issues or recommendations have been identified.

When at least one issue is identified after the testing procedures are executed, a listing of one or more issues associated with the particular entity can be identified at 245. Each of the automated testing procedures may include functionality to add the specific issue to the list. Alternatively, another suitable component or process can add the issues. Additionally, at 250, a location within the particular entity at which each, or at least some, of the identified issues occur can be provided. The compiler (e.g., a lexer and/or parser) or anther suitable component can identify, during compiling, hints or indications of where the location of the identified issue may have occurred. In some instances, only the issue is identified, while in others, the location may also be identified. At 255, at least one solution may be identified in associated with at least one of the identified issues. The solutions may be or can include a default solution associated with a particular issue based on one or more predefined solutions linked to or associated with particularly identified issues (e.g., in issue database 152), or the solutions may be dynamically generated with a specific proposed modification or action relevant to the specific context of the identified issue.

At 260, a response is generated associated with the testing operations related to the particular entity. The response can include, for example, a listing or identification of particular issues identified and, in some cases, a location within the particular entity (or entity definition) at which particular issues occur and/or where the particular issue is relevant. In some instances, the at least one solution corresponding to a particular issue can be included in the generated response. Still further, a hyperlink or other mechanism for navigation may be provided within the response, such that users or developers associated with the particular entity can be provided the report and access, without additional searching or actions, the particular locations where errors have been identified. When combined with one or more proposed solutions, developers may be able to fix or modify the particular entity, or at least begin to fix or modify the entity, immediately upon receipt of the response using the included navigation options or controls. At 265, the generated response can be provided for presentation to at least one user or developer associated with the particular entity. The at least one user or developer can include the user or developer associated with the initial request to execute the performance and usability analysis, or a user or developer responsible for the creation and development of the particular entity.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A method associated with a performance testing framework, the method executed by at least one processor and comprising:
receiving a request to execute a performance and usability analysis on a particular entity within a cloud development system;
identifying an entity type associated with the particular entity;
determining, based on the identified entity type and from a repository of automated testing procedures, a first set of automated testing procedures corresponding to the particular entity and context-specific to the identified entity type;
executing the first set of automated testing procedures on the particular entity; and
providing, for presentation to a user interface, a set of results associated with the execution of the first set of automated testing procedures.

2. The method of claim 1, the method further comprising:
accessing an entity definition associated with the particular entity, the entity definition containing at least one operation performed by the particular entity; and
determining, based on the entity definition, a second set of automated testing procedures corresponding to at least one of the at least one operations performed by the particular entity;
wherein executing the first set of automated testing procedures on the particular entity comprises executing the first and second set of automated testing procedures on the particular entity; and
providing the set of results comprises providing the set of results associated with the execution of the first set of automated testing procedures and a set of results associated with the execution of the second set of automated testing procedures.

3. The method of claim 2, wherein the entity definition includes at least one of an identification of a particular function performed by the particular entity, a particular format of the particular entity, and one or more programming languages associated with the particular entity.

4. The method of claim 2, wherein determining the second set of automated testing procedures corresponding to the at least one of the at least one operations performed by the particular entity comprises determining the second set of automated testing procedures based on the identified entity type and the entity definition of the particular entity.

5. The method of claim 1, wherein identifying an entity type associated with the particular entity is based on at least one of a file name extension of the particular entity, metadata associated with the particular entity, one or more attributes or parameters associated with or related to the particular entity, and an entry associated with the particular entity included in a lookup table or index storing information related to a plurality of entities.

6. The method of claim 1, wherein providing the set of results associated with the execution of the first set of automated testing procedures includes identifying at least one issue corresponding to the set of results of the execution.

7. The method of claim 6, wherein identifying the at least one issue includes identifying a location within the particular entity associated with at least one of the at least one identified issues.

8. The method of claim 1, wherein the request to execute the performance and usability analysis on the particular entity comprises an automatically triggered request in response to a developer action associated with development of the particular entity.

9. A system comprising:
at least one processor; and
a memory communicatively coupled to the at least one processor, the memory storing instructions which, when executed, cause the at least one processor to perform operations comprising:
receiving a request to execute a performance and usability analysis on a particular entity within a cloud development system;
identifying an entity type associated with the particular entity;
determining, based on the identified entity type and from a repository of automated testing procedures, a first set of automated testing procedures corresponding to the particular entity and context-specific to the identified entity type;
executing the first set of automated testing procedures on the particular entity; and
providing, for presentation to a user interface, a set of results associated with the execution of the first set of automated testing procedures.

10. The system of claim 9, the operation further comprising:
accessing an entity definition associated with the particular entity, the entity definition containing at least one operation performed by the particular entity; and
determining, based on the entity definition, a second set of automated testing procedures corresponding to at least one of the at least one operations performed by the particular entity;
wherein executing the first set of automated testing procedures on the particular entity comprises executing the first and second set of automated testing procedures on the particular entity; and
providing the set of results comprises providing the set of results associated with the execution of the first set of automated testing procedures and a set of results associated with the execution of the second set of automated testing procedures.

11. The system of claim 10, wherein the entity definition includes at least one of an identification of a particular function performed by the particular entity, a particular format of the particular entity, and one or more programming languages associated with the particular entity.

12. The system of claim 10, wherein determining the second set of automated testing procedures corresponding to the at least one of the at least one operations performed by the particular entity comprises determining the second set of automated testing procedures based on the identified entity type and the entity definition of the particular entity.

13. The system of claim 9, wherein identifying an entity type associated with the particular entity is based on at least one of a file name extension of the particular entity, metadata associated with the particular entity, one or more attributes or parameters associated with or related to the particular entity, and an entry associated with the particular entity included in a lookup table or index storing information related to a plurality of entities.

14. The system of claim 9, wherein providing the set of results associated with the execution of the first set of automated testing procedures includes identifying at least one issue corresponding to the set of results of the execution.

15. The system of claim 14, wherein identifying the at least one issue includes identifying a location within the particular entity associated with at least one of the at least one identified issues.

16. The system of claim 9, wherein the request to execute the performance and usability analysis on the particular entity comprises an automatically triggered request in response to a developer action associated with development of the particular entity.

17. A non-transitory computer-readable medium storing instructions which, when executed, cause at least one processor to perform operations comprising:
receiving a request to execute a performance and usability analysis on a particular entity within a cloud development system;
identifying an entity type associated with the particular entity;
determining, based on the identified entity type and from a repository of automated testing procedures, a first set of automated testing procedures corresponding to the particular entity and context-specific to the identified entity type;
executing the first set of automated testing procedures on the particular entity; and
providing, for presentation to a user interface, a set of results associated with the execution of the first set of automated testing procedures.

18. The computer-readable medium of claim 17, the operation further comprising:
accessing an entity definition associated with the particular entity, the entity definition containing at least one operation performed by the particular entity; and
determining, based on the entity definition, a second set of automated testing procedures corresponding to at least one of the at least one operations performed by the particular entity;
wherein executing the first set of automated testing procedures on the particular entity comprises executing the first and second set of automated testing procedures on the particular entity; and
providing the set of results comprises providing the set of results associated with the execution of the first set of automated testing procedures and a set of results associated with the execution of the second set of automated testing procedures.

19. The computer-readable medium of claim 18, wherein determining the second set of automated testing procedures corresponding to the at least one of the at least one operations performed by the particular entity comprises determining the second set of automated testing procedures based on the identified entity type and the entity definition of the particular entity.

20. The computer-readable medium of claim 17, wherein providing the set of results associated with the execution of the first set of automated testing procedures includes identifying at least one issue corresponding to the set of results of the execution, and wherein identifying the at least one issue includes identifying a location within the particular entity associated with at least one of the at least one identified issues.
